(19) United States
(12) Patent Application Publication
(10) Pub. No.: US 2016/0079807 A1
(43) Pub. Date: Mar. 17, 2016

(54) UNINTERRUPTIBLE POWER SUPPLY WITH INVERTER, CHARGER, AND ACTIVE FILTER

(71) Applicant: HEWLETT-PACKARD DEVELOPMENT COMPANY, L.P., Houston, TX (US)

(72) Inventor: Hai Ngoc Nguyen, Houston, TX (US)

(21) Appl. No.: 14/787,685

(22) PCT Filed: Jun. 25, 2013
(86) PCT No.: PCT/US2013/047483

§ 371 Date: Oct. 28, 2015

(51) Int. Cl. H02J 9/06; H02M 1/42; H02M 7/44

(52) U.S. Cl. CPC H02J 9/061; H02M 7/44; H02M 1/42

(57) ABSTRACT

Examples disclose an uninterruptible power supply comprising an integrated circuit. The integrated circuit comprises a charger to charge a battery and an inverter to deliver output power from the battery to a load. The integrated circuit further comprises an active filter to reduce input current to the uninterruptible power supply by compensating a power factor corresponding to input power.

### BACKGROUND

An uninterruptible power supply is an electric device which provides power to a load when a power source may fail. The uninterruptible power supplies are utilized to minimize losses in a data center, computers and/or servers.

### BRIEF DESCRIPTION OF THE DRAWINGS

In the accompanying drawings, like numerals refer to like components or blocks. The following detailed description references the drawings, wherein:

FIG. 1 is a block diagram of an example uninterruptible power supply including an integrated circuit and battery to receive input power and deliver output power to a load, the integrated circuit is further including a charger, an inverter, and an active filter;

FIG. 2A is a diagram of an example three phase power line for an uninterruptible power supply including a controller, battery, and integrated circuit to receive input power and deliver output power to load;

FIG. 2B is a diagram of an example structure of an integrated circuit coupled to a battery through a switch;

FIG. 2C is an example data table illustrating various conditional events in which a controller monitors the output power for a specified threshold;

FIG. 3 is a flowchart of an example method to receive an input power by a charger, deliver output power by an inverter, and compensate a power factor corresponding to the input power by an active filter;

FIG. 4 is a flowchart of an example method to receive an input power by a charger, deliver output power by an inverter, compensate a power factor corresponding to the input power by an active filter, and monitor the output power to determine whether the output power is above or below a threshold;

FIG. 5 is a flowchart of an example method to contemporaneously operate at least two of the following: a charger, an inverter, and an active filter; and

FIG. 6 is a block diagram of an example computing device with a processor to execute instructions in a machine-readable storage medium for receiving input power by a charger, delivering output power by an inverter, and compensating a power factor by an active filter.

### DETAILED DESCRIPTION

Uninterruptible power supplies within power systems provide protection from input power interruptions by supplying energy to loads. The uninterruptible power supply (UPS) may be employed with functionalities; however, the UPS may include separate conversions of these functionalities. These functionalities may include but should not limited to, an active filter, a charger, and/or an inverter. These components exist separately from each other, creating a mutual exclusiveness to each other. For example, the charger may work when the battery needs charging, but during the charge time, the inverter and and the active filter may not operate since the power supply may not be able to support the load. Thus, the UPS may not operate more than one given function at a given time. Additionally, the UPS may pass the load power factor to the source. Low load power factor increases input current. Power factors vary depending on the type of load. Thus, the active filter is employed as a separate external correction to correct the power factor of the load. Furthermore, the separation of these components increases space and costs of a power system.

To address these issues, examples disclosed herein provide an uninterruptible power supply (UPS) comprising an integrated the circuit to receive input power. The integrated circuit includes a charger to charge a battery, an inverter to deliver output power to a load from a battery, and an active filter to compensate a power factor associated with the input power. Including each of these components into the integrated circuit provides additional functionality of the UPS without increasing the cost and space. Further, including each of these components in the integrated circuit enables the UPS to provide three different functionalities without addition of separate external components.

Additionally, integrating these components into the circuit enables the UPS to operate at least two of these components at any given time. This provides a mutual inclusiveness of the components in which at least two of these components (i.e., the charger, the inverter, and the active filter) may operate together as opposed to three separate circuits.

In another implementation, the examples provide the integrated circuit is to simultaneously operate at least two of the components together. Operating at least two of the components (i.e., the charger, the inverter, and the active filter) together, provides an efficiency feature to the UPS so the functions corresponding to each component may operate simultaneously.

In a further example, the input power is part of a three-phase input and the charger is a three-phase charger. Providing the three-phase charger enables the UPS to balance itself when receiving the input power (e.g., current) among the three phases. For example, the battery charger may draw its input power from a single phase in a three-phase application, causing an unbalancing of the input power among the three phase power lines. In this example, the battery may receive one-third of the total input power among the three phase power lines and may be unable to support the load. The three-phase charger enables the UPS to support the load with the three-phase power lines.

In a further example, a controller coupled to the UPS monitors the output power provided to the load. In this example, if the output power is above or below a specified threshold, the controller either idles the active filter or operates the active filter to compensate the power factor associated with the input power. Idling or operating the active filter depending on whether the output power is above or below the threshold provides an additional management function to the UPS to operate efficiently in delivering the output power.

In summary, examples disclosed herein provide an uninterruptible power supply integrated with a charger, inverter, and active filter to provide three different functionalities without increasing the cost and space with three separate external components. Additionally, the examples disclosed herein provide a mutual inclusiveness in which at least two of the components (i.e., the charger, the inverter, and the active filter) may operate together as opposed to three separate circuits.

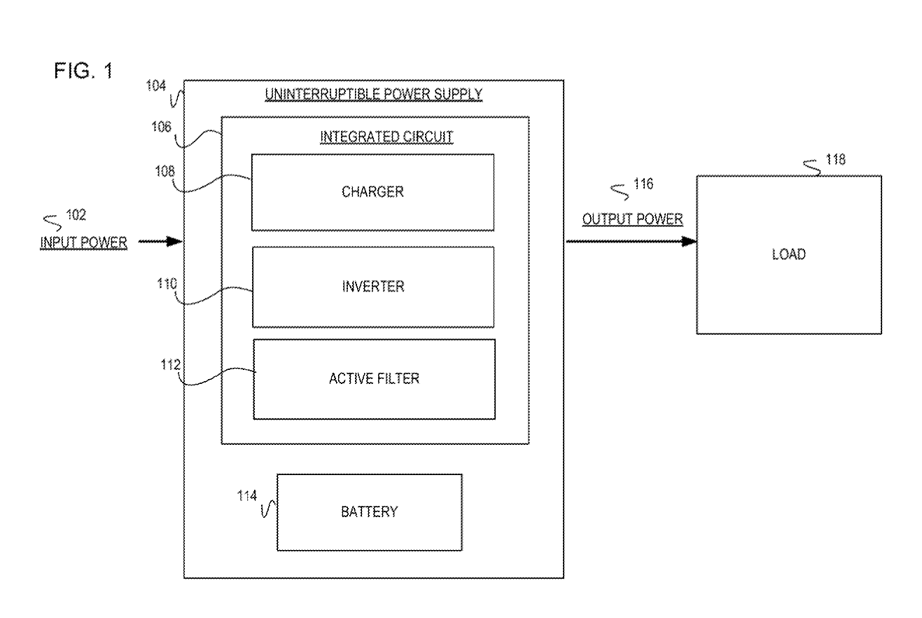

Referring now to the figures, FIG. 1 is a block diagram of an example uninterruptible power supply 104 to provide output power 116 to a load 118 when a power source within a power system may fail. The uninterruptible power supply 104 receives an input power 102 from the power source and includes an integrated circuit 106 and a battery 114. The integrated circuit 106 includes a charger 108 to receive the input power 102 to charge the battery 114, an active filter 112 to compensate a power factor associated with the input power 102, and an inverter 110 to convert the direct current stored at the battery 114 to an alternating current to provide as output power 116 to the load 118.

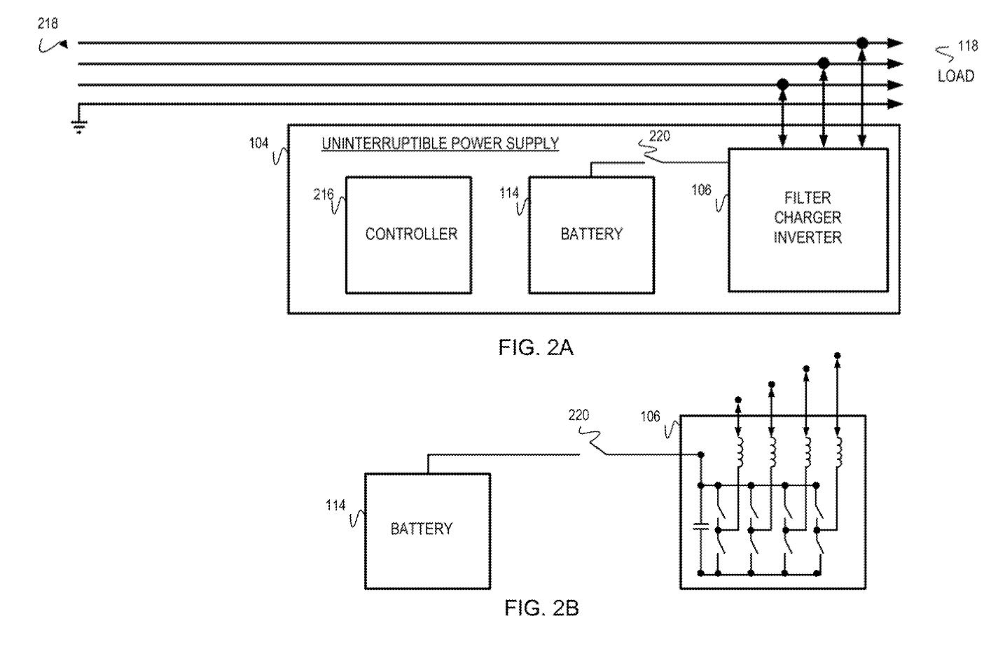

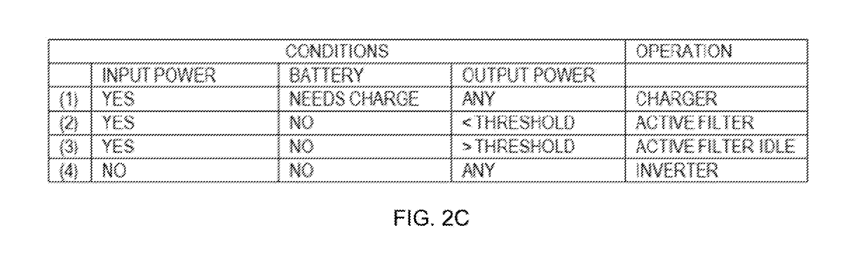

The input power 102 is the power transmitted by the power source (not illustrated) and received by the uninterruptipble power supply 104. The input power 102 is an electrical charge provided to the power supply 104 and as such, may include current, voltage, and/or electrical charge. In one implementation, the input power 102 is alternating current provided by a utility power source. The uninterruptible power supply 104 receives input power 102 and provides output power 116 to the load 118. Implementations of the uninterruptible power supply 104 include a power feed, power source, generator, power circuit, energy storage, electrical power system, or other type of power supply capable of receiving input power 102 and providing output power 116 to the load 118. Further, the uninterruptible power supply 104 may include additional components not illustrated in FIG. 2. For example, the power supply 104 may include a controller to manage and control the functions and/or operations of the power supply 104. This implementation is described in detail in the next figure.

The integrated circuit 106 is a circuit board integrated with electrical components 108, 110, and 112. The integrated circuit 106 may include multiple inductors, switches, and capacitors to provide connections and operations between the charger 108, inverter 110, and active filter 112. In one implementation, the integrated circuit 106 may contemporaneously operate at least two of the components 108, 110, and 112 within an overlapping time period. For example, the charger may receive input power 102 to charge the battery 114 while during this time, the active filter 112 may also compensate a power factor associated with the input power 102. In another implementation, the integrated circuit 106 may simultaneously operate at least two of the components 108, 110, and 112. In this manner, the components 108, 110, and 112 may be mutually inclusive to each other as the components 108, 110, and 112 may be capable of simultaneous operation with one another. These implementations are explained in detail in later figures. Integrating each of the electrical components on the integrated circuit 106 provides each of the functions corresponding to the electrical components 108, 110, and 112 on a circuit board rather than building separate circuits for each component 108, 110, and 112.

The charger 108 receives input power 102 and provides the electrical charge to the battery 114. The charger 108 is part of the integrated circuit 106 and is used to charge the battery 114 by directing an electrical current to the battery 114. In one implementation, the charger 108 receives the input power 102 as alternating current and converts it is direct current to charge the battery 114.

The inverter 110 is an electrical power converter as part of the integrated circuit 106 internal to the uninterruptible power supply 104. In one implementation, the battery 114 stores the electrical charge received by the charger 108 as direct current which the inverter 110 receives this direct current and converts it into alternating current which is delivered as the output power 116 to the load 118.

The active filter 112 utilizes active electrical components, such as an amplifier to compensate a power factor (not illustrated) associated with the input power 102 received by the charger 108. The active component is an electrical component that may produce energy and/or power gain. In this manner, the active filter 112 uses active electrical components to compensate the power factor. The power factor is indicator of the efficiency of a power system. The power factor is associated with the input power 102 as the active filter obtains measurements of the current and voltage corresponding to the input power 102 to determine the power factor. In one implementation, the active filter 112 reduces the input power (e.g., current) to the uninterruptible power supply 104 by compensating the power factor.

The battery 114 is an electrical component internal to the uninterruptible power supply 104 to store a charge from the charger 108 and provide the charge to the inverter 110. The battery 114 utilizes electro-type chemical cells to store and provide the electrical energy and as such, implementations of the battery 114 include a non-rechargeable battery, rechargeable battery, electro-chemical battery, mechanical battery, or other type of electrical energy storage component capable of receiving electrical charge from the charger 108 and providing the electrical charge to the inverter 110 for transmission to the load 118.

The output power 116 is delivered by the inverter 110 from the battery 114 to the load 118. The load 118 may utilize power different from the input power 102, thus the integrated circuit 106 may process the input power 102 to generate the output power 116 to provide the load 118. The output power 116 is an electrical charge provided by the power supply 104 to the load 118 and as such, may include current, voltage, and/or electrical charge. In one implementation, the power stored by the battery 114 may include a direct current, thus the inverter may convert the direct current to alternating current as the output power 116 to the load 118.

The load 118 is part of the power system and receives output power 116 from the uninterruptible power supply 104. The load 118 may include a data center, computer, and/or server in which to receive the output power 116 from the uninterruptible power supply 104 to minimize losses in an occurrence of an interruption of power from the power source (not illustrated). Implementations of the load 118 include an electrical circuit, electrical impendance, or other type of computing circuit capable of receiving output power 116.

FIG. 2A is a block diagram of an example three phase power line 218 for an uninterruptible power supply 104 to receive input power and deliver output power to a load 118. The uninterruptible power supply 104 includes a controller 216 to manage functions and operations of the power supply 104, a battery 114 to receive a charge through a switch 220 from the integrated circuit 106. The integrated circuit 106 includes an active filter 112, a charger 108, and an inverter 110 as in FIG. 1. In one implementation, the controller 216 coupled to the the integrated circuit 106 contemporaneously operates at least two of the electrical components 108, 110, and 112. In another implementation, the controller 216 simultaneously operates at least two of the electrical components 108, 110, and 112 together. These implementations are described in detail in later figures. The internal electrical connections of the uninterruptible power supply 106 between each of the electrical components 108, 110, and 112 are illustrated in FIG. 2B.

The three phase line 218 includes three separate conductors to carry input power from a power source (not illustrated) to the uninterruptible power supply 104 and to deliver output power from the uninterruptible power supply 104 to the load 118. In this manner, each conductor is bi-directional with the uninterruptible power supply 104, as the power supply 104 may both receive input power and transmit output power on each of these conductors of the three phase power lines 218. The bi-directional feature is indicated with the bi-directional arrows from each conductor to and from the integrated circuit 106. The bi-directional feature eliminates the need for separate conductors for each electrical component 108, 110, and 112. Each of the conductors as part of the three-phase power lines 218 provide alternating currents and voltages that are offset in time by one-third of a period of time. For example, a magnitude of voltage from one conductor may be offset in time from a magnitude of voltage from a second conductor. This may cause issues if the charger internal to the integrated circuit 106 may draw input power from a single phase among the three-phase power lines or conductors as this may cause unbalancing of power. For example, for a 20 kilowatt uninterruptible power supply 104, there may be 20 kilowatts supplied to the load 118, but the battery 114 may deliver 2 kilowatts ( 1/10) of the total output power because the charger may have drawn input power from one of the phases. This may additionally cause power factor issues. Thus, the controller 216 may monitor the output power for a specified threshold to ensure the power supply 104 is operating with minimal losses.

The controller 216 manages the functions and operations of the uninterruptible power supply 104. Further, the controller 216 is coupled to the integrated circuit 106 and the battery 114 to manage the charger, the inverter, the active filter, and the battery 114. Although FIG. 2A may not illustrate this coupling, this was done for illustration purposes and not for limiting purposes. For example, the controller 216 may be coupled to the integrated circuit 106 through an electrical connection (not illustrated). In one implementation, the controller 216 monitors the output power provided by the power supply 104 and as such, the controller 216 may signal to the active filter whether to compensate a power factor or remain idle. This implementation is described in detail in later figures. Implementations of the controller 216 include a processor, circuit logic, a set of instructions executable by a processor, a microchip, chipset, electronic circuit, microprocessor, semiconductor, microcontroller, central processing unit (CPU), or other device capable of managing the integrated circuit 106 and the battery 114.

The switch 220 connects the battery 114 to the integrated circuit 106. In one implementation, depending on which component (i.e., the charger, the inverter, and/or the active filter) the uninterruptible power supply 104 operates, the controller 216 may transmit a signal to the switch 220 to connect and/or disconnect accordingly. For example, the controller 216 may transmit a signal to connect the switch 220 between the integrated circuit 106 and the battery 114 as the charger may charge the battery 114 while the inverter also provides output power to the load 118. Implementations of the switch 220 include an electromechanical device, electrical device, switching voltage regulator, transistor, relay, logic gate, binary state logic, or other type of electrical device that may connect the battery 114 to the integrated circuit 106.

FIG. 2B is a block diagram of example integrated circuit 106 coupled to the battery 114 through the switch 220. Specifically, FIG. 2B illustrate the internal electrical elements to the integrated circuit 106 to comprise the charger, the inverter, and the active filter. As illustrated in FIG. 2B, each bi-directional conductor is received by the integrated circuit 106 at an inductor and through a series of switches. When these switches are connected, the capacitor on the left side of the integrated circuit 106 receives an electrical charge to charge the battery 114 once the switch 220 is connected. Although FIG. 2B illustrates the integrated circuit 106 as including multiple inductors connected in series with multiple switches and a capacitor, this was done for illustration purposes and not for limiting implementations. For example, the integrated circuit 106 may include multiple capacitors and/or transistors which are not illustrated. Rather, FIG. 2B illustrates a simplified infrastructure implementation for the integrated circuit 106.

FIG. 2C is an example data table illustrating various conditional events in which the controller 216 monitors the output power for a specified threshold. The specified threshold is illustrated as the output power column under the various conditions. At the left of the table are each of the numbered conditional events that may occur and in turn the operation of the uninterruptible power supply 104. Each of these conditions are performed by the integrated circuit 106 with the charger, the inverter, and the active filter.

For example, during a first condition, the power supply 104 receives input power, the battery 114 may indicate no charge, while there may be multiple levels of output power. This condition illustrates when the battery 114 may need to charge through the charger and thus the other components (i.e., the active filter and the inverter) may remain idle. During the second condition, the load 118 may include a certain percentage that might decrease the power factor or the output power is below the specified threshold. In the second condition, the active filter may operate to compensate the power factor while the inverter and the charger may remain idle. During the third condition, the output power is above the specified threshold, thus the power factor may indicate to the uninterruptible power supply 104, the power system is efficiently operating and thus the electrical components (i.e., the charger, the inverter, and the active filter) may remain idle. During the fourth condition, the input power may be lost, thus the inverter may operate while the other active components (i.e., the charger and the active filter) remain idle.

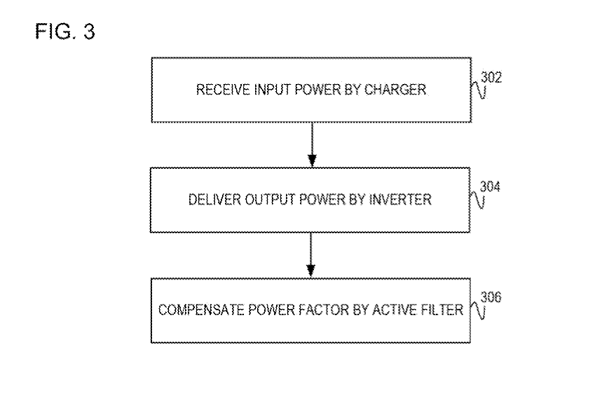

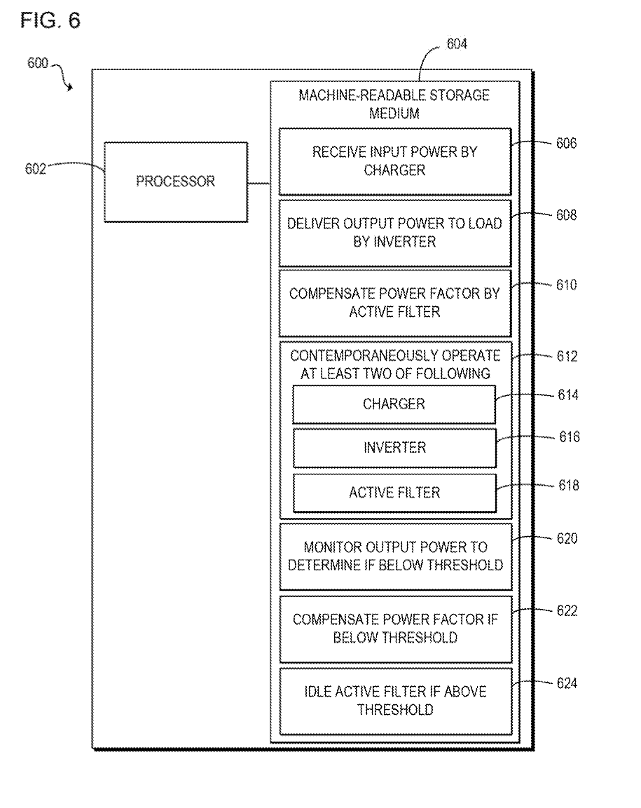

FIG. 3 is a flowchart of an example method to receive an input power by a charger, deliver output power by an inverter, and compensate a power factor corresponding to the input power by an active filter. The charger, the inverter, and the active filter are integrated on a circuit within an uninterruptible power supply. Integrating each of these functionalities on the integrated circuit provides additional functionalities to the uninterruptible power supply without increasing real estate and cost. Further, this also enables the uninterruptible power supply to operate two or more functionalities at a given time. In discussing FIG. 3, references may be made to FIGS. 1-2C to provide contextual examples. Further, although FIG. 3 is described as implemented the uninterruptible power supply 104 as in FIG. 1, it may be executed on other suitable components. For example, FIG. 3 may be implemented in the form of executable instructions on a machine readable storage medium, such as machine-readable storage medium 604 as in FIG. 6.

At operation 302, the charger receives input power from a source. The input power is used to charge a battery within the uninterruptible power supply. In one implementation, the input power may include alternating current, so the charger may convert the alternating current to direct current for the battery to charge. Charging the battery enables the uninterruptible power supply to provide output power to a load if a power source within a power system may fail.

At operation 304, the inverter delivers output power front the battery charged at operation 302 to the load. In one implementation, the inverter may convert the direct current from the battery to alternating current to supply to the load. In another implementation, operation 306 may occur prior to operation 304.

At operation 306, the active filter compensates a power factor corresponding to the input power received at operation 302. The active filter uses active components, such amplifiers to compensate the power factor, thereby reducing the input current by the uninterruptible power supply. The power factor is an indication of how efficiently the uninterruptible power supply and/or the integrated circuit may be operating. The power factor is measured from both the voltage and current from an input. In an ideal operation, both the measurement and current follow the same path, such as sine wave and the power factor would be around one. If either of these measurements are out of phase, this affects the power factor which may increase or decrease. This provides efficient use in which to monitor and/or correct the operation of the integrated circuit to receive and provide power.

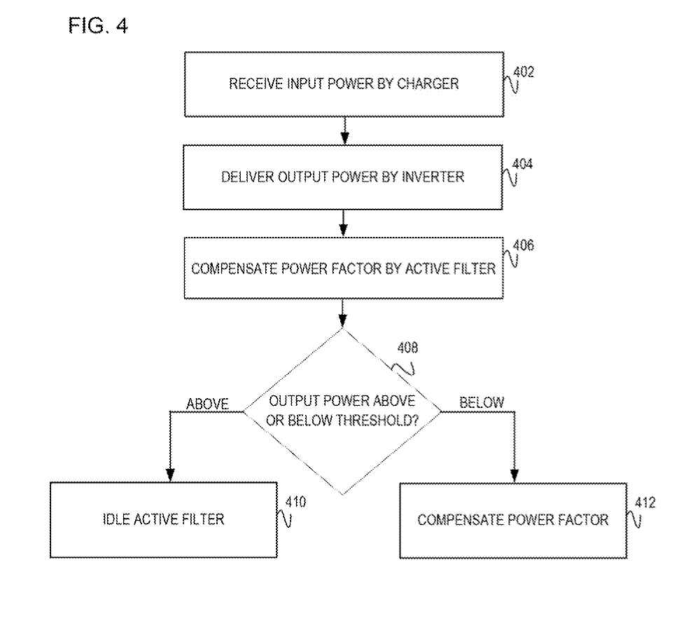

FIG. 4 is a flowchart of an example method, executable by an uninterruptible power supply, to receive input power, deliver output power, and compensate a power factor corresponding to the input power. Additionally, the method of FIG. 4 monitors the output power to determine whether the output power is above or below a particular threshold. If the output power is above the threshold, a controller coupled to the uninterruptible power supply idles an active filter. If the output power is below the threshold, the active filter compensates the power factor. In discussing FIG. 4, references may be made to the components FIGS. 1-2C to provide contextual examples. Further, although FIG. 4 is described as implemented the uninterruptible power supply 104 as in FIG. 1, it may be executed on other suitable components. For example, FIG. 4 may be implemented in the form of executable instructions on a machine readable storage medium, such as machine-readable storage medium 604 as in FIG. 6. Each of the operations 402-406 are performed by an electrical component, such as the charger, the inverter, and the active filter. Each of these components are integrated on a circuit together within the uninterruptible power supply and as such, operations 402-414 are considered the functions performed by each of these electrical components from within the uninterruptible power supply.

At operation 402, the charger receives input, power from a power source to charge a battery internal to the uninterruptible power supply. At operation 404, the inverter, coupled to the battery, delivers output power to a load. The battery is charged at operation 402 for the inverter to receive the power to deliver to the load. In one implementation, the charger receives alternating current and converts it to direct current to charge the battery. Once the battery receives the direct current, a switch may close to direct the path of current to the inverter. The inverter may receive the direct current and convert to alternating current to deliver to the load. At operation 406, the active filter compensates the power factor associated with the input power received at operation 402. Operations 402-406 may be similar in functionality to operations 302-306 as in FIG. 3.

At operation 408, a controller internal to the uninterruptible power supply monitors the output power to determine if the output power is below a specified threshold. The threshold may be specified according to power regulations limits which may include a maximum and a minimum limit of output power. The maximum and minimum limits of power ensure the uninterruptible power supply is efficiently operating without causing damage and/or under utilizing resources. In one implementation, the threshold may be set by an administrator of a power system. The method proceeds to operations 410-412 depending on whether the output power is above or below the specified threshold. In one implementation, if the output power is above the threshold, the method proceeds to operation 410. In another implementation, if the output power is below the threshold, the method proceeds to operation 412.

At operation 410, if the output power is above the specified threshold, the controller transmits a signal to the active filter to idle. In one implementation, the active filter may power down.

At operation 412, if the output power is below the specified threshold, the controller transmits a signal to activate the active filter. The active filter may then compensate the input power factor to ensure the voltage and current associated with the input power are in phase with one another.

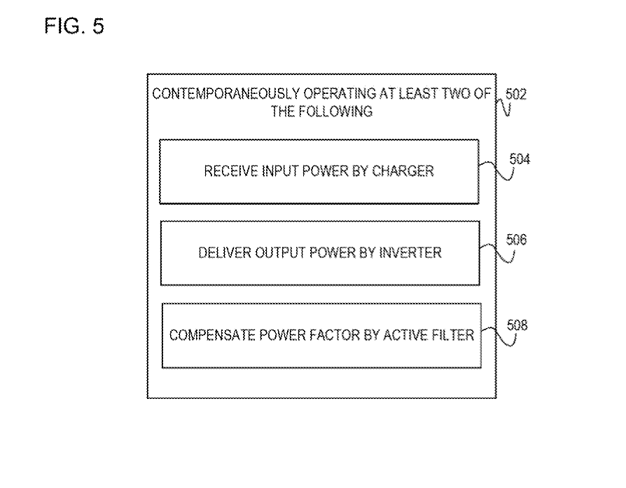

FIG. 5 is a flowchart of an example method to contemporaneously operate at least two of the following: a charger, an inverter, and an active filter. Each of these electrical components are internal to an uninterruptible power supply and as such, may be integrated on a single integrated circuit. This integrated circuit may be managed by a controller internal to the power supply. The controller manages the functions and operations of the uninterruptible power supply. In discussing FIG. 5, references may be made to the components FIGS. 1-2C to provide contextual examples. Further, although FIG. 5 is described as implemented the uninterruptible power supply 104 as in FIG. 1, it may be executed on other suitable components. For example, FIG. 5 may be implemented in the form of executable instructions on a machine readable storage medium, such as machine-readable storage medium 604 as in FIG. 6.

At operation 502, the controller coupled to the uninterruptible power supply contemporaneously operates at least two electrical components on the integrated circuit. Contempraneously operating at least two electrical components refers to the operation of the at least two electrical components within an overlapping time period. For example, the controller may operate the active filter 112 to compensate an input power factor and also operate the charger 108 within the same overlapping time to charge the battery 114 as in FIG. 1. Contempraneously operating at least two electrical components, the method proceeds to operate at least two operations 504-508. In this regard, the electrical components corresponding to operations 504-508 may be operated by the controller within the same period of time. In one implementation, the controller may proceed to simultaneously process at least two of the operations 504-508 for functioning the corresponding electrical components. In another implementation, operating at least two of the electrical components corresponding to operations 504-508 provides a mutual inclusiveness of these components to each other. Mutual inclusiveness includes the functioning of two of the components happening at or near the same period of time. This enables at least two of the operations 504-508 to occur in a simultaneous manner. Including the simultaneous operation of the active filter, charger, and inverter enables the uninterruptible power supply to operate in an efficient manner to deliver power in a near instantaneous manner to a load without minimal interruptions in a power system. In a further implementation, the controller may operate the charger at operation 504 simultaneously with the active filter at operation 508. In yet a further implementation, the controller may operate the charger at operation 504 simultaneously with the inverter at operation 506. Yet still in another implementation, the controller may operate the charger at operation 504, the inverter at operation 506, and the active filter at operation 508 simultaneously with one another.

At operation 504, the controller may operate the charger to receive the input power to charge the battery. The input power may be provided by an electrical utility source that distributes electricity through a transmission line. In one implementation, the charger coupled to the uninterruptible power supply may receive the input power through a three-phase transmission line or conductors. The three-phase transmission conductors include at least three conductors to carry electricity between a power source to the uninterruptible power supply. Each of the conductors provides alternating current and voltages that are offset in time by one-third of a period of time. For example, a magnitude of voltage from one conductor may be offset in time from a magnitude of voltage from a second conductor. In another implementation, the conductor coupled to the uninterruptible power supply used to receive the input power may also deliver the output power at operation 508. In this regard, the transmission line is considered a bi-directional conductor that may both receive and provide power from the power supply. In a further implementation, the charger receives input power in the the form of alternating current and converts the alternating current to direct current for use by the battery. The battery stores the power from the charger for use by the inverter at operation 508 to provide to the load.

At operation 506, the controller may operate the inverter to deliver output power from the battery to the load. The battery may store power from the charger until it reaches a particular threshold at which point the inverter will use the power to deliver on the conductor to the load. The inverter is an electrical power converter which changes direct current into alternating current. The converted alternating current may include multiple voltages and frequencies with the use of appropriate transformers, switching, and control circuits. In one implementation, the power provided by the battery to the inverter is in the form of direct current which the inverter may convert to alternating current for use by the load. In another implementation, the inverter converts the battery voltage (i.e., stored voltage) into a voltage for use by the load.

At operation 508, the controller may operate the active filter to compensate the input power factor corresponding to the input power received at operation 504. The active filter is a type of analog electronic filter that uses active components, such as an amplifier to compensate a power factor associated with the input power received at operation 504. The power factor is an indicator used by the power supply to determine how efficiently the power system may be operating to supply power to the load. The power factor is measured from both the current and voltage of the input power received at operation 504. In this manner, the power supply may also include a meter and/or sensor to measure the voltage and current. In another implementation, the power factor of alternating current power system is the ratio of real power to apparent flowing to the load. The power factor is a dimensionless value between negative to positive one. Due to energy stored at the load and returned to the source of input power or due to a non-linear load that distorts the wave shape of the current and/or voltage drawn from the power source, there may be a distortion of the current and/or voltage received by the power supply. For the power supply to operate in an efficient manner, the power factor may be as close to one indicating the power system efficiency. Thus, the active filter may adjust the power factor to reach one so the power system operates with minimal losses. In another implementation, the active filter reduces the input power (e.g., current) received by the uninterruptible power supply to compensate the power factor.

FIG. 6 is a block diagram of computing device 600 with a processor 602 to execute instructions 606-624 within a machine-readable storage medium 604. Specifically, the computing device 600 with the processor 602 is to receive input power, deliver output power, and compensate a power factor. Although the computing device 600 includes processor 602 and machine-readable storage medium 604, it may also include other components that would be suitable to one skilled in the art. For example, the computing device 600 may include the integrated circuit 106 and/or the battery 114 as in FIG. 1. The computing device 600 is an electronic device with the processor 602 capable of executing instructions 606-624, and as such embodiments of the computing device 600 include a computing device, mobile device, client device, personal computer, desktop computer, laptop, tablet, video game console, or other type of electronic device capable of executing instructions 606-624. The instructions 606-624 may be implemented as methods, functions, operations, and other processes implemented as machine-readable instructions stored on the storage medium 604, which may be non-transitory, such as hardware storage devices (e.g., random access memory (RAM), read only memory (ROM), erasable programmable ROM, electrically erasable ROM, hard drives, and flash memory).

The processor 602 may fetch, decode, and execute instructions 606-624 to receive input power, deliver output power, and compensate a power factor accordingly. In one implementation, once executing instructions 606-610, the processor may then execute instructions 620-624. In another implementation, once executing instructions 606-610, the processor 602 may also simultaneously execute instructions 612-618. Specifically, the processor 602 executes instructions 606-610 to: receive input power from a source, the input power is used by a charger for charging a battery; then delivering output power from an inverter coupled to the battery, the output power is provided to a load; and compensating a power factor by an active filter, the power factor corresponds to the input power and is used to reduce the input current to an uninterruptible power supply. The processor may then execute instructions 612-618 to contemporaneously operate at least two of the following: the charger to power the battery; an inverter to convert power from the battery from alternating current to direct current for providing to the load; and the active filter to compensate the power factor corresponding to the input power. Once executing instructions 606-610 and/or instructions 612-618, the processor 602 may execute instructions 620-624 to: monitor the output power provided to the load to determine if the power is above or below a specified threshold; if the output power is below the specified threshold, the active filter may compensate the power factor to reduce input current received by the uninterruptible power supply; if the output power is above the specified threshold, the controller managing operations of the uninterruptible power supply idles the active filter.

The machine-readable storage medium 604 includes instructions 606-624 for the processor to fetch, decode, and execute. In another embodiment, the machine-readable storage medium 604 may be an electronic, magnetic, optical, memory, storage, flash-drive, or other physical device that contains or stores executable instructions. Thus, the machine-readable storage medium 604 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 604 may include an application and/or firmware which can be utilized independently and/or in conjunction with the processor 602 to fetch, decode, and/or execute instructions of the machine-readable storage medium 604. The application and/or firmware may be stored on the machine-readable storage medium 604 and/or stored on another location of the computing device 600.

In summary, examples disclosed herein provide an uninterruptible power supply integrated, with a charger, inverter, and active filter to provide three different functionalities without increasing the cost and space with three separate external components. Additionally, the examples disclosed herein provide a mutual inclusiveness in which at least two of the components (i.e., the charger, the inverter, and the active filter) may operate together as opposed to three separate circuits.

I claim:

1. An uninterruptible power supply comprising:
an integrated circuit further comprising:
a charger, coupled to an input power and a battery, to charge the battery;
an inverter, coupled to the battery and a load, to deliver output power from the battery to the load; and
an active filter to reduce input current to the uninterruptible power supply by compensating a power factor corresponding to the input power.

2. The uninterruptible power supply of claim 1 wherein the integrated circuit is to contemporaneously operate at least two of the following: the inverter, the charger, and the active filter.

3. The uninterruptible power supply of claim 1 further comprising:
the battery to provide the output power to the inverter for delivery to the load.

4. The uninterruptible power supply of claim 1 wherein the input power a three-phase input and the charger is a three-phase charger.

5. The uninterruptible power supply of claim 1 further comprising:
a controller to monitor the output power, wherein if the output power is below a threshold, the controller is to idle the active filter.

6. The uninterruptible power supply of claim 5 wherein if the output power is above the threshold, the controller is to operate the active filter to compensate the power factor.

7. The uninterruptible power supply of claim 1 further comprising:
a bidirectional line to provide the input power to the inverter and to deliver the output power from the inverter to the load.

8. A non-transitory machine-readable storage medium encoded with instructions executable by a processor of a computing device, the storage medium comprising instructions to:
receive input power, by a charger, to charge a battery within an uninterruptible power supply;
deliver output power, by an inverter coupled to the battery, to a load; and
reduce input current to the uninterruptible power supply by compensating a power factor corresponding to the input power by an active filter, wherein the charger, the inverter, and the active filter are integrated on a circuit within the uninterruptible power supply and are mutually inclusive.

9. The non-transitory machine-readable storage medium including the instructions of claim 8 and further comprising instructions to:
contemporaneously operate at least two of the following: the inverter, the charger, and the active filter.

10. The non-transitory machine-readable storage medium including the instructions of claim 8 further comprising instructions to:
monitor the output power to determine whether the output power is below a threshold;
compensate the power factor corresponding to the input power, by the active filter, based on a determination the output power is below the threshold; and
idle the active filter, based on a determination the output power is above the threshold.

11. A method, executable by an uninterruptible power supply, comprising:
receiving, by a charger, an input power to charge a battery;
delivering, by an inverter, output power from the battery to a load; and
compensating, by the active filter, a power factor corresponding to the input power to reduce input current to the uninterruptible power supply, wherein the charger, the inverter, and the active filter are mutually inclusive to each other.

12. The method of claim 11 further comprising:
integrating the charger, the inverter, and the active filter on a circuit board within the uninterruptible power supply.

13. The method of claim 11 wherein the mutual inclusiveness of the charger, the inverter, and the active filter includes contemporaneously operating at least two of the following: receiving the input power, delivering output power, and compensating the power factor.

14. The method of claim 11 further comprising:
monitoring the output power to determine whether the output power is below a threshold;
compensating the power factor associated with the input power based the determination the output power is below the threshold.

15. The method of claim 11 wherein upon a determination the output power is above the threshold, the method further comprising:
idling the active filter.
